(19) United States
(12) Patent Application Publication
(10) Pub. No.: US 2016/0207073 A1
(43) Pub. Date: Jul. 21, 2016

(54) SCRAPER DEVICE, SCRAPING ARRANGEMENT AND GUIDE RAIL

(71) Applicant: DELAVAL HOLDING AB, Tumba (SE)

(72) Inventors: Patrick DESAULNIERS, Tumba (SE); Eric VALLIERES, Tumba (SE)

(21) Appl. No.: 14/914,716

(22) PCT Filed: Sep. 3, 2014
(86) PCT No.: PCT/SE2014/051011

§ 371 Date: Feb. 26, 2016

(30) Foreign Application Priority Data
Sep. 5, 2013 (SE) 1351028-4
May 5, 2014 (SE) 1450529-1

(51) Int. Cl. B08B 1/00; A01K 5/00; A01K 1/01

(52) U.S. Cl. CPC B08B 1/005; A01K 1/0128; A01K 5/00

(57) ABSTRACT

A scraper device for an animal holding facility includes a trolley to be displaced along a guide member by a wire, a scraper element attached to the trolley to be dragged along a surface to be scraped, and first and second wire engagement mechanisms connected to the trolley. The first wire engagement mechanism has a first wire locking direction, a first wire release direction, and includes a first release mechanism for automatic releasing of the wire. The second wire engagement mechanism has a second wire locking direction, a second wire release direction, and includes a second release mechanism for automatic releasing of the wire. The first and second wire locking directions are directed in opposite directions and the first and second wire release directions are directed in opposite directions.

### TECHNICAL FIELD

The present invention relates to a scraper device adapted to be used in an animal holding facility, a scraping arrangement adapted to be used in an animal holding facility, and a guide rail adapted to be used with a scraper device in an animal holding facility.

### BACKGROUND

In animal holding facilities material requires displacing, e.g. feed in a feeding alley may require to be moved within reach of feeding animals, and manure may need to be scraped into a manure gutter or in between slats of a slatted floor. For such purposes various scraper arrangements are known.

US 2011/132267 discloses a material-shifting system for shifting scattered material, such as livestock feed, closer to a barrier. The system includes at least one traveling unit having an angled push-head which is coupled to a shuttle. Preferably, the shuttle is driven along a rail by a remote driving. As the shuttle travels along the rail, the push head pushes material scattered over a surface towards the barrier. From the figures the rail appears to be an I-beam.

Scraper arrangements may comprise one, two or more separate scraper elements, each scraper element being adapted to scrape a different surface. Scraper arrangements may comprise different kinds of driving arrangements. Feed scrapers as well as manure scrapers may be dragged along a surface by a wire connected to a motor. In other scraper arrangements, in particular manure scraper arrangements, the scraper elements may be driven by hydraulic cylinders. Commonly, each scraper element is driven in two opposite directions along a surface. Accordingly, a driving arrangement of a scraper arrangement has to be able to drive the scraper elements in these two opposite directions.

In wire driven scraper arrangements comprising two or more scraper elements, either all scraper elements have to be connected to one wire driven by a motor, or each scraper element requires a dedicated wire and motor. In the latter case the cost of the arrangement increases with the number of motors.

### SUMMARY

When several scraper elements are connected to one wire driven by a motor, problems may be encountered with the aligning of the scraper elements along the wire, since each scraper element has to scrape an entire length of a relevant surface before being dragged in an opposite direction. Aligning of the scraper elements along the wire may prove difficult in changing temperature conditions, when the wire length increases under warm conditions and decreases under cold conditions. Accordingly, there is a need for a scraper arrangement comprising wire driven scraper devices, which arrangement is insensitive to alignment errors between individual scraper devices along the wire, and wherein the scraper devices still are able to scrape entire lengths of relevant surfaces.

It is an object of the present invention to provide a scraper device which independently of its positioning along a driving wire is able to scrape an entire length of a relevant surface.

According to an aspect of the invention, the object is achieved by a scraper device adapted to be used in an animal holding facility, the scraper device comprising a trolley adapted to be displaced along a guide member by a wire, a first wire engagement mechanism connected to the trolley and being adapted to engage the trolley with the wire, and a scraper element attached to the trolley and being adapted to be dragged along a surface to be scraped of the animal holding facility to displace material laying on said surface to be scraped. The scraper device further comprises a second wire engagement mechanism connected to the trolley and being adapted to engage the trolley with the wire. The first wire engagement mechanism has a first wire locking direction, a first wire release direction, and comprises a first release mechanism adapted to automatically release the wire from a first locking engagement upon actuation by a first actuator element. The second wire engagement mechanism has a second wire locking direction, a second wire release direction, and comprises a second release mechanism adapted to automatically release the wire from a second locking engagement upon actuation by a second actuator element. The first and second wire locking directions are directed in opposite directions and the first and second wire release directions are directed in opposite directions.

Since the first and second wire locking directions are directed in opposite directions and the first and second wire release directions are directed in opposite directions, the first wire engagement mechanism engages with the wire as the wire is moved in a first direction and releases the wire as the wire is moved in an opposite second direction. Conversely, the second wire engagement mechanism engages with the wire as the wire is moved in the second direction and releases the wire as the wire is moved in the first direction. Since the first and second wire engagement mechanisms comprise respective first and second release mechanisms adapted to automatically release the wire from a first and a second locking engagement, the first and second wire engagement mechanisms may be released as the wire is moved in the respective first and second locking directions when the scraper device reaches an end position at respective ends of a relevant surface. Thus, the wire may move through both the first and second engagement mechanisms without moving the scraper device when an end position has been reached. Accordingly, the wire may be moved in a direction for a longer distance than the length of the relevant surface to be scraped to ensure that the scraper device reaches an end position of the relevant surface. As a result, the above mentioned object is achieved.

It has been realized by the inventors that the scraper device need not be permanently attached to a wire used for driving the scraper device and that a releasable wire engagement mechanism will provide for the wire to be released from the scraper device to enable the wire to be driven in each direction for longer distances than the length of one or more surfaces to be scraped.

The scraper device may be adapted to scrape feed on a feeding alley, e.g. in order to move feed within reach of feeding animals. The scraper device may be adapted to scrape manure, e.g. into a manure gutter or in between slats of a slatted floor. The scraper device may be adapted to scrape bedding material to be distributed. The animal holding facility may comprise a barn or a pasture. In a barn there may be provided one or more feeding alleys having surfaces to be scraped, and/or one or more animal walking passages having surfaces which require scraping from manure, and/or one or more bedding distribution surfaces requiring some kind of scraping. In connection with a pasture there may be provided one or more feeding alleys having surfaces to be scraped, and/or one or more animal walking passages having surfaces which require scraping from manure. The guide member may be adapted to guide the trolley along a surface to be scraped. When the wire is moved in a wire locking direction of a wire engagement mechanism, the wire engagement mechanism engages with the wire and the trolley is moved with the wire. When the wire is moved in a wire release direction of a wire engagement mechanism, the wire moves through the wire engagement mechanism without moving the trolley. A locking engagement of the wire means that the scraper device is engaged with the wire such that when the wire is moved, the scraper device will move with the wire. An automatic releasing of the wire from a locking engagement is to be interpreted as a releasing of the wire, which does not require manual intervention.

According to embodiments, the trolley may comprise guide elements adapted to abut against the guide member. In this manner it may be ensure that the trolley remains safely positioned in relation the guide member.

According to embodiments, the scraper element may be pivotably attached to the trolley such that the scraper element is pivotable away from the surface to be scraped. In this manner the surface to be scraped may be cleared from the scraper element.

According to embodiments, the first wire engagement mechanism may comprise a first cam cleat and the second wire engagement mechanism may comprise a second cam cleat. Each of the first and second cam cleats may comprise cleat members being adapted to receive the wire between the cleat members. In this manner the wire locking directions and the wire release directions may easily be achieved.

According to embodiments, the first cam cleat may comprise a first fixed cleat member fixedly connected to the trolley and a first movable cleat member movably connected to the trolley. The second cam cleat may comprise a second fixed cleat member fixedly connected to the trolley and a second movable cleat member movably connected to the trolley.

According to embodiments, the first movable cleat member may be pivotable about a first pivot axis and the second movable cleat member may be pivotable about a second pivot axis.

According to embodiments, the first release mechanism may comprise the first movable cleat member and a first follower element connected to the first movable cleat member, the first follower element being adapted to pivot the first movable cleat member upon actuation of the first follower element. The second release mechanism may comprise the second movable cleat member and a second follower element connected to the second movable cleat member, the second follower element being adapted to pivot the second movable cleat member upon actuation of the second follower element. In this manner each movable cleat member, which is involved with creating the locking direction and the release direction, may be affected to also open the locking engagement of the wire by means of actuation of the follower element.

According to embodiments, the first fixed cleat member and the second fixed cleat member may comprise wire engagement surfaces aligned along a wire direction of the wire.

According to embodiments, the first wire engagement mechanism may comprise a first wire guiding wheel rotatably connected to the trolley and the second wire engagement mechanism may comprise a second wire guiding wheel rotatably connected to the trolley. Each of the first and second wire guiding wheels may comprise a wire receiving groove, a surface of which is adapted to frictionally engage the wire. In this manner, as the wire may engage frictionally in the wire receiving grooves, the wire may be locked in the first and second wire locking directions by blocking of a respective rotation of the first and second wire guiding wheels.

According to embodiments, the scraper device may comprise a first ratchet mechanism associated with the first wire guiding wheel and a second ratchet mechanism associated with the second wire guiding wheel. In this manner the wire locking directions and the wire release directions may be achieved by respective blocking of the first and second wire guiding wheels utilizing the first and second ratchet mechanisms. Suitably, the first and second ratchet mechanisms have opposite wire guiding wheel rotation blocking directions, and consequently opposite wire guiding wheel free rotating directions.

According to embodiments, the first ratchet mechanism may comprise a first gear connected to, or forming part of, the first wire guiding wheel and a first pawl pivotably connected to the trolley, and the second ratchet mechanism may comprise a second gear connected to, or forming part of, the second wire guiding wheel and a second pawl pivotably connected to the trolley. Suitably, the first gear and the first pawl provide a first wire guiding wheel rotation blocking direction opposite to a second wire guiding wheel rotation blocking direction, the latter being provided by the second gear and the second pawl.

According to embodiments, the first release mechanism may comprise the first pawl and a first abutment member connected to the first pawl. The first abutment member may be adapted to pivot the first pawl upon actuation of the first abutment member. The second release mechanism may comprise the second pawl and a second abutment member connected to the second pawl. The second abutment member may be adapted to pivot the second pawl upon actuation of the second abutment member. In this manner the first and second pawls, which are involved with creating the first and second locking directions by blocking rotation of the respective first and second wire guiding wheels, may be affected to also release the respective first and second locking engagement of the wire by means of actuation of the first and second abutment members, respectively.

According to embodiments, each of the first and second wire guiding wheels may comprise a further wire receiving groove, a surface of which is adapted to frictionally engage the wire. In this manner, as the wire also may engage frictionally in the further wire receiving grooves, the wire may be locked in the first and second wire locking directions by blocking a rotation of the first and second wire guiding wheels, respectively.

According to a further aspect of the invention, there is provided a scraping arrangement adapted to be used in an animal holding facility, the scraping arrangement comprising a wire, a wire driving motor arrangement, and at least one scraper device according to any aspect or embodiment disclosed herein.

The above mentioned object is also achieved by such a scraper arrangement, in which a scraper device independently of its positioning along the driving wire is able to scrape an entire length of a relevant surface to be scraped.

According to embodiments, the wire may form an endless wire loop. In this manner a switching of direction of the wire may simply be performed by switching the direction of the wire motor driving arrangement.

According to embodiments, the scraping arrangement may further comprise wire directing elements for directing the wire along a wire path. In this manner it may be ensured that the wire follows a specified path. Furthermore, the wire may be directed along all desired surfaces to be scraped in an animal holding facility.

According to embodiments, the wire driving motor arrangement may be arranged to drive the wire in a forward direction and a reverse direction.

According to embodiments, the scraping arrangement may comprise a first actuator element and a second actuator element. The first actuator element may comprise a first cam element having a first cam surface and the second actuator element may comprise a second cam element having a second cam surface. Each of the first and second cam elements is separate from the trolley and the wire and is adapted to be positioned at opposite ends of a traveling path of the scraper device. The first release mechanism is adapted to be actuated by the first cam surface at a first end of the traveling path. The second release mechanism is adapted to be actuated by the second cam surface at a second end of the traveling path. In this manner the wire may move through both the first and second engagement mechanisms without moving the scraper device at the first end of the traveling path as well as at the second end of the traveling path. Thus, the scraper device will always scrape an entire length of a surface to be scraped and stop at the ends of the surface to be scraped while the wire may be moved in a particular direction over a longer distance than the length of a relevant surface.

According to embodiments, the first follower element of the first release mechanism may be adapted to abut against the first cam surface at a first end of the traveling path to actuate the first movable cleat member of the first release mechanism. The second follower element of the second release mechanism may be adapted to abut against the second cam surface at a second end of the traveling path to actuate the second movable cleat member of the second release mechanism. In this manner the follower elements may be actuated by abutting against the cam surfaces.

According to embodiments, the first abutment member of the first release mechanism may be adapted to abut against the first cam surface at a first end of the traveling path to actuate the first pawl of the first release mechanism. The second abutment member of the second release mechanism may be adapted to abut against the second cam surface at a second end of the traveling path to actuate the second pawl of the second release mechanism. In this manner the abutment members may be actuated by abutting against the cam surfaces.

According to embodiments, the wire may extend in at least one loop around the first and second wire guiding wheels, the wire at least partially extending through the wire receiving grooves of the first and second wire guiding wheels. In this manner the wire may frictionally engage with the surfaces of the first and second wire guiding wheels. When a rotation of one of the wire guiding wheels is blocked, the trolley may be pulled by the wire along a surface to be scraped.

According to embodiments, the scraping arrangement may comprise a first pivot guiding element and a second pivot guiding element. Each pivot guiding element may be adapted to bear against the scraper element to pivot the scraper element away from the surface to be scraped at opposite ends of a traveling path of the scraper device. In this manner the scraper element may be pivoted away from the surface to be scraped simply by moving the scraper device such that the scraper element bears against a relevant guiding element.

According to embodiments, the scraping arrangement may comprise at least one further scraper device according to any aspect or embodiment disclosed herein, wherein the at least one further scraper device may be arranged to scrape at least one further surface to be scraped of the animal holding facility to displace material laying on said at least one further surface to be scraped. Since the wire may be moved also through the further scraper device at end positions of a traveling path thereof, the further scraper device need not be aligned with the first scraper device along the wire. Furthermore, the lengths of surfaces to be scraped by the further scraper device and the first scraper device need not be the same. The scraper device with the shorter traveling path will stop at its end positions and the wire will move through this scraper device while the wire will continue to move the other scraper device to its end positions.

In an animal holding facility certain types of scraper devices require a guide rail, along which the scraper device is arranged to be moved. Such a guide rail may be problematic to mount to a supporting structure such as a wall or a barrier in the animal holding facility.

According to a further aspect of the invention, there is provided a guide rail adapted to support a scraper device and adapted to be mounted to a supporting structure of an animal holding facility. The guide rail is elongated, extends along a rail direction and comprises two flanges, which two flanges are adapted to abut against guide elements of the scraper device. The guide rail comprises a section being connected to the two flanges, which section is arranged to space the two flanges from the supporting structure. The section is substantially U-shaped and arranged between the two flanges so as to space the two flanges from each other, such that access to an inner surface of the section is permitted when an outer surface of the section abuts against the supporting structure.

Since the inner surface of the U-shaped section is accessible as defined above, the guide rail may easily be mounted to a supporting structure in an animal holding facility by connector elements, such as bolts, extending through a bottom portion of the U-shaped section. As a result the above mentioned object is achieved.

According to embodiments, a bottom portion of the U-shaped section may have a bent shape such that the inner surface may be convex and the outer surface may be concave. In this manner when the guide rail is attached to a supporting structure tightening of a connector element, such as a bolt, extending through the bottom portion of the U-shaped section will flatten, at least locally, the bottom portion. A spring force resulting from the flattening may ensure a safe frictional engagement between the guide rail and the supporting structure.

According to embodiments, the guide rail comprises two end portions, wherein at each end portion the guide rail may be provided with at least one slot extending in the rail direction.

In this manner two guide rails adjoining each other along a supporting structure may be aligned by temporarily inserting a guiding element in the slots at adjoining end portions of the two guide rails.

According to embodiments, in the scraper device according to any aspect or embodiment disclosed herein, the guide member may comprise at least one guide rail according to aspects or embodiments disclosed herein.

According to embodiments, in the scraper arrangement according to any aspect or embodiment disclosed herein, the guide member may comprise at least one guide rail according to aspects or embodiments disclosed herein.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a scraper device according to embodiments,

FIGS. 2 and 3 illustrate an interior of a trolley of the scraper device illustrated in FIG. 1,

FIG. 4 illustrates a cross section through the scraper device illustrated in FIGS. 1-3,

FIGS. 5 and 6 illustrate embodiments of a scraping arrangement,

FIG. 7 illustrates embodiments of a guide rail adapted to support a scraper device, and

FIGS. 8 and 9 illustrate a scraper device according to embodiments.

### DETAILED DESCRIPTION

Aspects of the present invention will now be described more fully. Like numbers refer to like elements throughout. Well-known functions or constructions will not necessarily be described in detail for brevity and/or clarity.

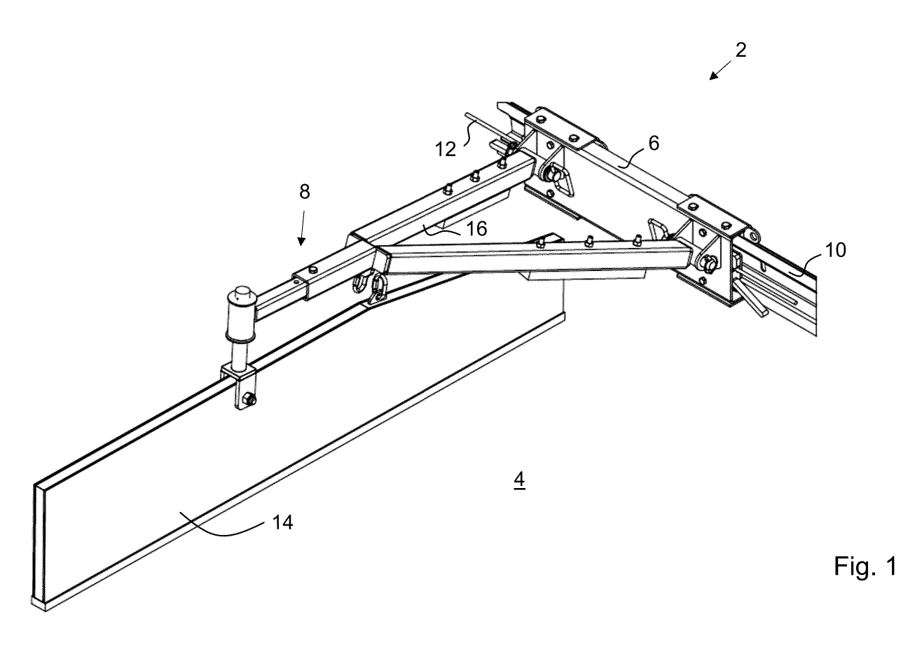

FIG. 1 illustrates a scraper device 2 according to embodiments. The scraper device 2 is adapted to be used in an animal holding facility, a surface 4 of which is to be scraped. The scraper device 2 comprises a trolley 6 and a scraper element 8 attached to the trolley 6. The trolley 6 is adapted to be displaced along a guide member 10 by a wire 12. Only a portion of the wire 12 is illustrated in FIG. 1. The scraper element 8 is adapted to be dragged along the surface 4 to be scraped to displace material laying on said surface to be scraped. More specifically, the scraper element 8 comprises a scraper blade arrangement 14 which is to be dragged along the surface 4. The scraper blade arrangement 14 is attached to the trolley 6 by means of a beam 16. Applied in a feeding solution, the scraper element 8 may for instance scrape the surface of a feeding alley to displace feed within the reach of animals feeding from the feeding alley. Applied in a manure handling solution, the scraper element 8 may for instance scrape a passage littered with animal droppings to move the droppings to a manure gutter at an end of the passage, or down between slats of a slatted floor.

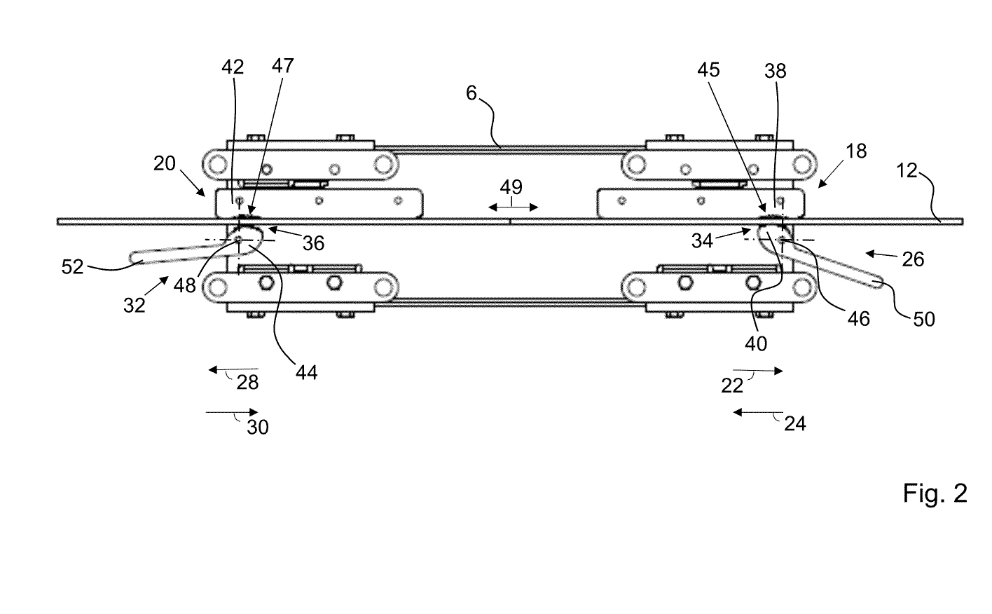

FIG. 2 illustrates an interior of the trolley 6 of the scraper device 2 illustrated in FIG. 1. A first wire engagement mechanism 18 is connected to the trolley 6 and is adapted to engage the trolley 6 with the wire 12. A second wire engagement mechanism 20 is connected to the trolley 6 and is adapted to engage the trolley 6 with the wire 12. The first wire engagement mechanism 18 has a first wire locking direction 22, a first wire release direction 24, and comprises a first release mechanism 26 adapted to automatically release the wire 12 from a first locking engagement upon actuation by a first actuator element. The second wire engagement mechanism 20 has a second wire locking direction 28, a second wire release direction 30, and comprises a second release mechanism 32 adapted to automatically release the wire 12 from a second locking engagement upon actuation by a second actuator element. The wire locking and release directions 22, 24, 28, 30 are illustrated with arrows in FIG. 2. The first and second wire locking directions 22, 28 are directed in opposite directions and the first and second wire release directions 24, 30 are directed in opposite directions. The term wire locking direction means that when the wire 12 is moved in the wire locking direction, the wire engagement mechanism 18, 20 is in locking engagement with the wire 12 such that the trolley 6 is moved with the wire 12. The term wire release direction means that when the wire 12 is moved in the wire release direction, the wire engagement mechanism 18, 20 releases the wire 12 to move unengaged through the wire engagement mechanism 18, 20.

In FIG. 2 the first release mechanism 26 is unactuated and thus, the wire 12 will be engaged or unengaged by the first release mechanism 26 depending on the movement direction of the wire 12. The second release mechanism 32 is actuated and thus, the second wire locking direction 28 of the second release mechanism 32 is disabled. This means that when the wire 12 is moved in the first wire release direction 24 and the second wire locking direction 28, the wire 12 will pass through the trolley 6 without moving the trolley 6. The positions of the first and second release mechanisms 26, 32 as illustrated in FIG. 2 are held when the scraper device has reached an end of a surface to be scraped, i.e. at one end of a travelling path of the scraper element. Conversely, at an opposite end of a travelling path of the scraper element, the first release mechanism 26 will be actuated and the second release mechanism 32 will be unactuated. Thus, the wire 12 moving in the first locking direction 22 and the second release direction 30 will pass through the trolley 6 without moving the trolley 6.

The first and second release mechanisms 26, 32 are actuated by non-shown actuator elements. Such actuator elements are positioned at each end of the travelling path of the scraper element such that a respective of the first and second release mechanisms 26, 32 is actuated by a respective element when the trolley 6 moved by the wire 12 reaches a respective end of the travelling path.

In these embodiments the first wire engagement mechanism 18 comprises a first cam cleat 34 and the second wire engagement mechanism 20 comprises a second cam cleat 36. The wire 12 is received between cleat members of the first and second cam cleats 34, 36. The first cam cleat 34 comprises a first fixed cleat member 38 fixedly connected to the trolley 6 and a first movable cleat member 40 movably connected to the trolley 6. The second cam cleat 36 comprises a second fixed cleat member 42 fixedly connected to the trolley 6 and a second movable cleat member 44 movably connected to the trolley 6. The first movable cleat member 40 is pivotable about a first pivot axis 46 and the second movable cleat member 44 is pivotable about a second pivot axis 48. The first fixed cleat member 38 and the second fixed cleat member 42 comprise wire engagement surfaces 45, 47 aligned along a wire direction 49 of the wire 12.

In these embodiments, the first release mechanism 26 comprises the first movable cleat member 40 and a first follower element 50 connected to the first movable cleat member 40. Upon actuation, the first follower element 50 pivots the first movable cleat member 40 to release the wire 12 from a first locking engagement. Similarly, the second release mechanism 32 comprises the second movable cleat member 44 and a second follower element 52 connected to the second movable cleat member 44. Upon actuation, the second follower element 52 pivots the second movable cleat member 44 to release the wire 12 from a second locking engagement.

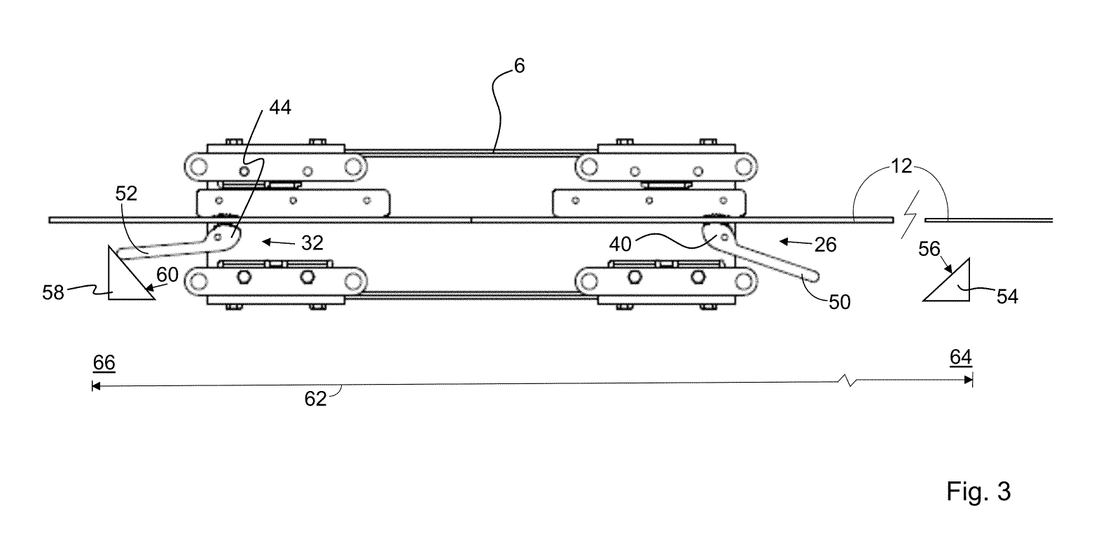

FIG. 3 again illustrates an interior of the trolley 6 of the scraper device 2 illustrated in FIG. 1. The scraper device forms part of a scraper arrangement comprising a first actuator element and a second actuator element. The first actuator element comprise a first cam element 54 having a first cam surface 56 and the second actuator element comprises a second cam element 58 having a second cam surface 60. Each of the first and second cam elements 54, 58 is separate from the trolley 6 and the wire 12. Each of the first and second cam elements 54, 58 is adapted to be positioned at opposite ends of a traveling path 62 of the scraper device 2. The first follower element 50 of the first release mechanism 26 is adapted to abut against the first cam surface 56 at a first end 64 of the traveling path 62 to actuate the first movable cleat member 40. The second follower element 52 of the second release mechanism 32 is adapted to abut against the second cam surface 60 at a second end 66 of the traveling path 62 to actuate the second movable cleat member 44. In FIG. 3, as discussed above in connection with FIG. 2, the second follower element 52 has been actuated. The second follower element 52 has been actuated by abutment against the second cam surface 60 of the second cam element 58. Thus, the second movable cleat member 44 has been pivoted to release the wire 12 from a locking engagement.

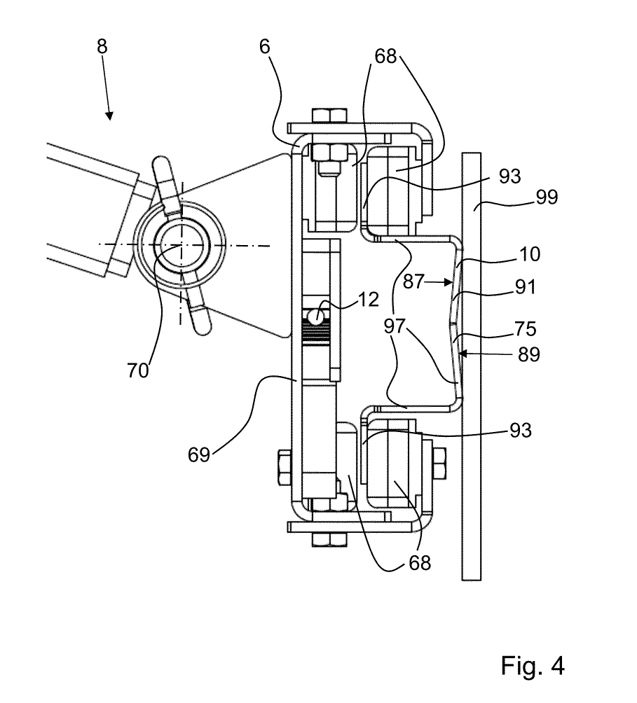

FIG. 4 illustrates a cross section through the scraper device 2 illustrated in FIGS. 1-3. In particular, the trolley 6 and its connection to the guide member 10 is shown. The trolley 6 comprises guide elements 68 adapted to abut against the guide member 10. The guide elements 68 abut against the guide member 10 to position the trolley 6 in relation to the guide member 10. The guide elements 68 may comprise a low friction material such as nylon or PTFE such that the trolley 6 may be moved along the guide member 10 by the wire 12. The guide elements 60 may be fixedly connected to a body 69 of the trolley 6. Alternatively, one or more of the guide elements 68 may be rotatably connected to the body 69 of the trolley 6.

The scraper element 8 is pivotably attached to the trolley 6 such that the scraper element 8 is pivotable away from a relevant surface to be scraped. The scraper element 8 is pivotable about a third axis 70.

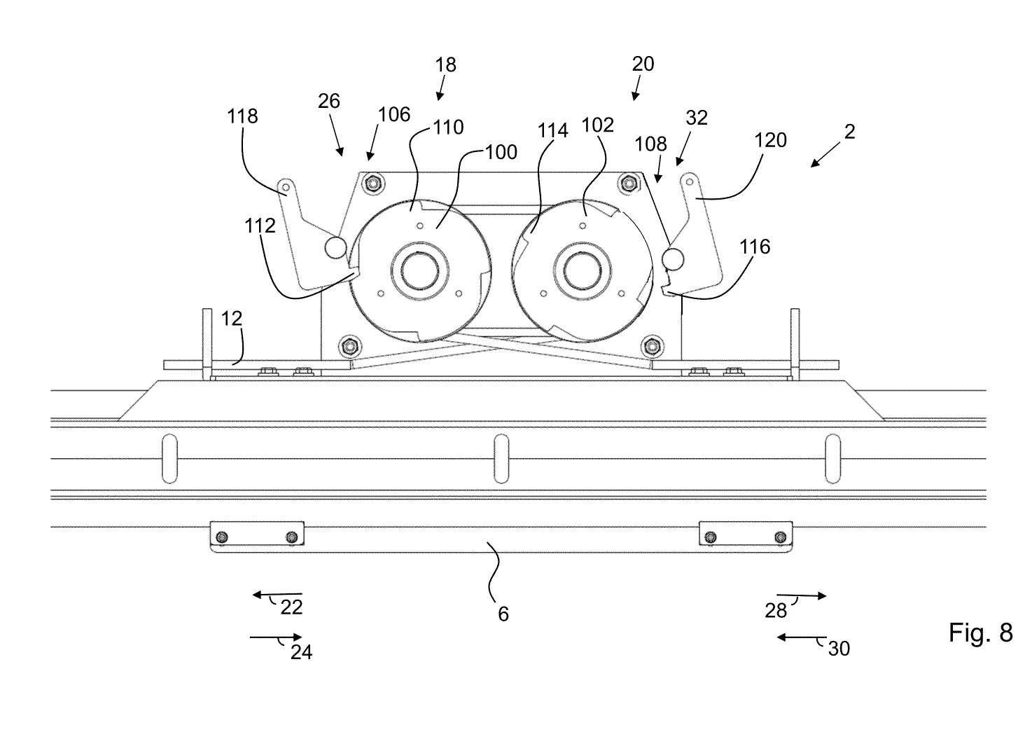

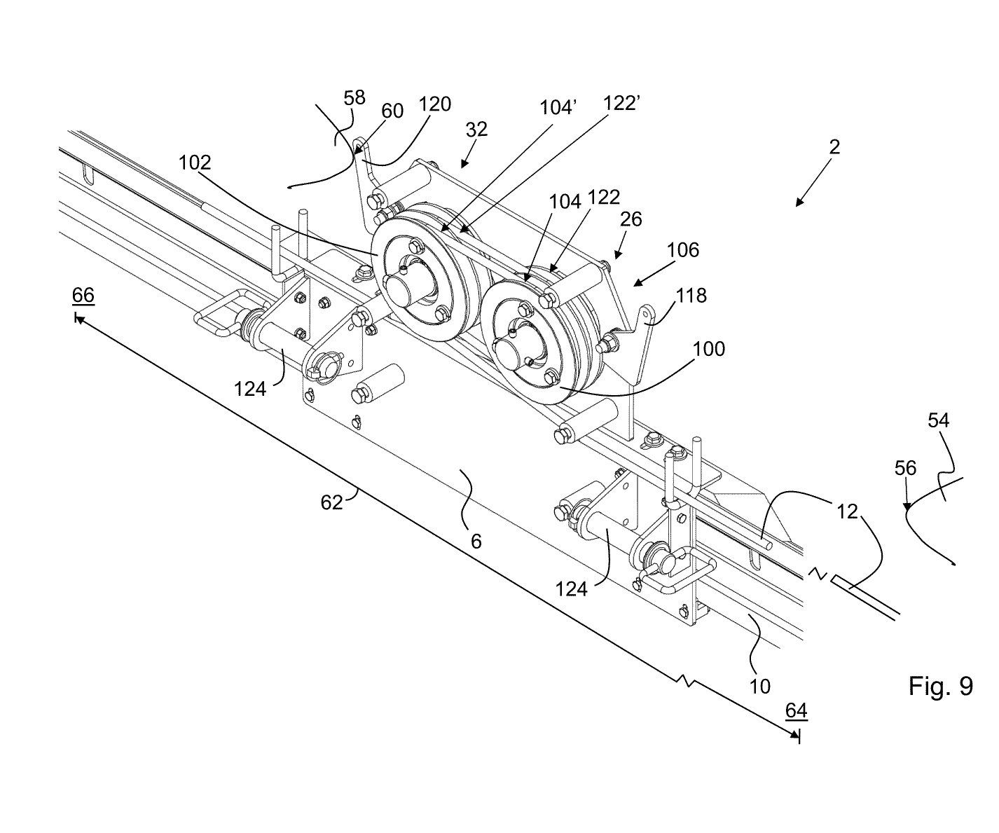

FIGS. 8 and 9 illustrate a scraper device 2 according to embodiments. Referring to FIG. 8, a first wire engagement mechanism 18 is connected to a trolley 6 and is adapted to engage the trolley 6 with a wire 12. A second wire engagement mechanism 20 is connected to the trolley 6 and is adapted to engage the trolley 6 with the wire 12. The first wire engagement mechanism 18 has a first wire locking direction 22 and a first wire release direction 24, and comprises a first release mechanism 26 adapted to automatically release the wire 12 from a first locking engagement upon actuation by a first actuator element. The second wire engagement mechanism 20 has a second wire locking direction 28 and a second wire release direction 30, and comprises a second release mechanism 32 adapted to automatically release the wire 12 from a second locking engagement upon actuation by a second actuator element. The wire locking and release directions 22, 24, 28, 30 are illustrated with arrows in FIG. 8. The first and second wire locking directions 22, 28 are directed in opposite directions and the first and second wire release directions 24, 30 are directed in opposite directions. The term wire locking direction means that when the wire 12 is moved in the wire locking direction, the wire engagement mechanism 18, 20 is in locking engagement with the wire 12 such that the trolley 6 is moved with the wire 12 in that direction. The term wire release direction means that when the wire 12 is moved in the wire release direction, the wire engagement mechanism 18, 20 releases the wire 12 to move unengaged through the wire engagement mechanism 18, 20.

In FIG. 8 the first release mechanism 26 is unactuated, and thus the wire 12 will be engaged or unengaged by the first release mechanism 26 depending on the movement direction of the wire 12. The second release mechanism 32 is actuated, and thus the second wire locking direction 28 of the second release mechanism 32 is disabled. This means that when the wire 12 is moved in the first wire release direction 24 and the second wire locking direction 28, the wire 12 will pass through the trolley 6 without moving the trolley 6. The positions of the first and second release mechanisms 26, 32 as illustrated in FIG. 8 are held when the scraper device has reached an end of a surface to be scraped, i.e. at one end of a travelling path of a scraper element attached to the trolley 6. Conversely, at an opposite end of a travelling path of the scraper element, the first release mechanism 26 will be actuated and the second release mechanism 32 will be unactuated. Thus, the wire 12 moving in the first locking direction 22 and the second release direction 30 will pass through the trolley 6 without moving the trolley 6.

The first and second release mechanisms 26, 32 are actuated by non-shown actuator elements. Such actuator elements are positioned at each end of the travelling path of the scraper element such that a respective of the first and second release mechanisms 26, 32 is actuated by a respective element when the trolley 6 moved by the wire 12 reaches a respective end of the travelling path.

In these embodiments the first wire engagement mechanism 18 comprises a first wire guiding wheel 100 rotatably connected to the trolley 6. The first wire guiding wheel 100 comprises at least one wire receiving groove. The second wire engagement mechanism 20 comprises a second wire guiding wheel 102 rotatably connected to the trolley 6. Also the second wire guiding wheel 102 comprises at least one wire receiving groove. The wire 12 extends partially through the wire receiving grooves of the first and second wire guiding wheels 100, 102 and engages frictionally with a surface of each wire receiving groove. Accordingly, when both wire guiding wheels 100, 102 are permitted to rotate freely on the trolley 6 and the wire 12 is subjected to a pulling force, the wire 12 engaging in the wire receiving grooves will rotate both wire guiding wheels 100, 102 as the wire 12 is pulled through the trolley 6. Conversely, when at least one wire guiding wheel 100, 102 is blocked from rotating and the wire 12 is subjected to a pulling force, the wire 12 engaging in the wire receiving groove of the at least one blocked wire guiding wheel forces the trolley 6 to be pulled along with the wire 12. In the latter case the wire 12 is locked in the first or second wire locking direction 22, 28.

A first ratchet mechanism 106 is associated with the first wire guiding wheel 100 and a second ratchet mechanism 108 is associated with the second wire guiding wheel 102. The first ratchet mechanism 106 is adapted to block and release a rotation of the first guiding wheel 100 and the second ratchet mechanism 108 is adapted to block and release a rotation of the second guiding wheel 102. The first ratchet mechanism 106 comprises a first gear 110 connected to, or forming part of, the first wire guiding wheel 100 and a first pawl 112 pivotably connected to the trolley 6. The second ratchet mechanism 108 comprises a second gear 114 connected to, or forming part of, the second wire guiding wheel 102 and a second pawl 116 pivotably connected to the trolley 6. The first and second gears 110, 114 each comprise a number of cogs. When the first and second pawls 112, 116 engage with cogs of the respective first and second gears 110, 114, the first and second wire guiding wheels 100, 102, respectively, are blocked from rotating in a wire guiding wheel rotation blocking direction. In an opposite wire guiding wheel free rotating direction each of the wire guiding wheels is rotatable. The first and second ratchet mechanisms 106, 108 have opposite wire guiding wheel rotation blocking directions, and opposite wire guiding wheel free rotating directions. In these embodiments the first and second pawls 112, 116 are brought in contact with the cogs of the first and second gears 110, 114 by means of gravity. Alternatively, or additionally, the first and second pawls 112, 116, may be biased towards the cogs of the first and second gears 110, 114.

In these embodiments the first release mechanism 26 comprises the first pawl 112 and a first abutment member 118 connected to the first pawl 112. The first abutment member 118 is adapted to pivot the first pawl 112 upon actuation of the first abutment member 118. The second release mechanism 32 comprises the second pawl 116 and a second abutment member 120 connected to the second pawl 116. The second abutment member 120 is adapted to pivot the second pawl 116 upon actuation of the second abutment member 120. Accordingly, upon actuation the first abutment member 118 pivots the first pawl 112 to release the wire 12 from a first locking engagement, and upon actuation the second abutment member 120 pivots the second pawl 116 to release the wire 12 from a second locking engagement.

With reference to FIG. 9 the scraper device 2 is illustrated forming part of a scraper arrangement comprising a first actuator element and a second actuator element. The first actuator element comprises a first cam element 54 having a first cam surface 56 and the second actuator element comprises a second cam element 58 having a second cam surface 60. Each of the first and second cam elements 54, 58 is separate from the trolley 6 and the wire 12. Each of the first and second cam elements 54, 58 is adapted to be positioned at opposite ends of a traveling path 62 of the scraper device 2. The first abutment member 118 of the first release mechanism 26 is adapted to abut against the first cam surface 56 at a first end 64 of the traveling path 62 to actuate the first pawl. The second abutment member 120 of the second release mechanism 32 is adapted to abut against the second cam surface 60 at a second end 66 of the traveling path 62 to actuate the second pawl. In FIG. 9, as discussed above in connection with FIG. 8, the second abutment member 120 has been actuated. The second abutment member 120 has been actuated by abutment against the second cam surface 60 of the second cam element 58. Thus, the second pawl has been pivoted to release the wire 12 from a locking engagement and the wire 12 may be pulled through the trolley 6 in a direction from the first end 64 towards the second end 66 of the traveling path 62, without moving the trolley 6. As the wire 12 is pulled in the opposite direction, the first wire guiding wheel 100 is blocked from rotating by the first ratchet mechanism 106, and the trolley 6 is pulled along with the wire 12 towards the first end 64 of the traveling path 62.

The wire 12 extends in at least one loop around the first and second wire guiding wheels 100, 102. The wire 12 extends at least partially through the wire receiving grooves 104, 104′ of the first and second wire guiding wheels 100, 102. In these embodiments each of the first and second wire guiding wheels 100, 102 comprises a further wire receiving groove 122, 122′, a surface of which is adapted to frictionally engage the wire 12. Consequently, in these embodiments the wire 12 extends in two loops around the first and second wire guiding wheels 100, 102.

Again, the trolley 6 is adapted to move along a guide member 10 as discussed e.g. in connection with FIG. 4. The trolley 6 comprises connection members 124 for pivotal connection of a scraper element, e.g. a scraper element 8 as discussed in connection with FIG. 1.

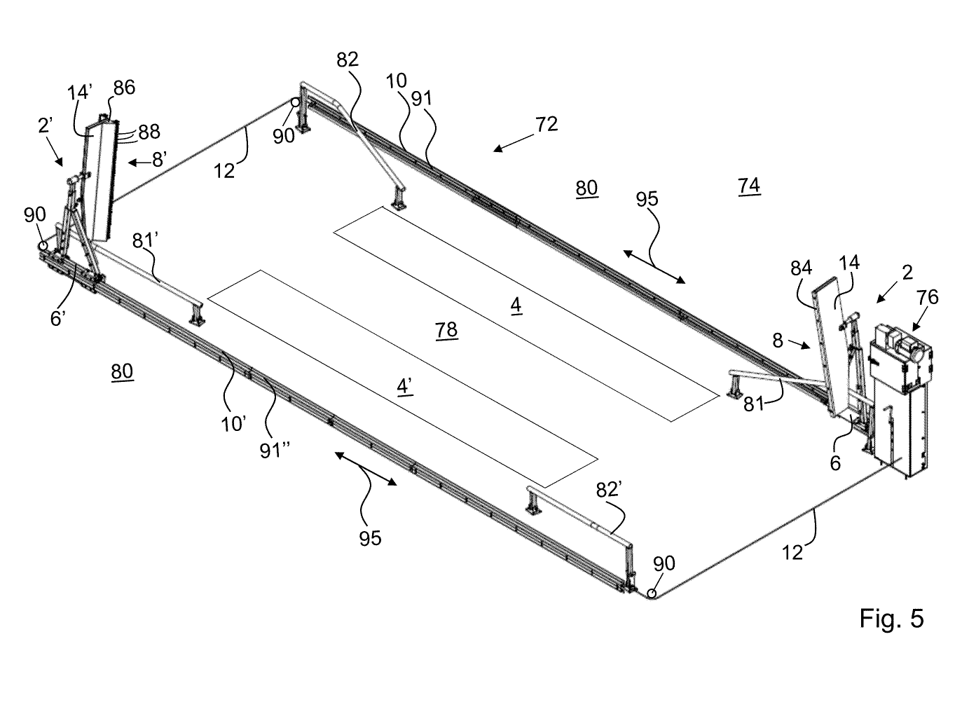

FIG. 5 illustrates embodiments of a scraping arrangement 72 arranged in an animal holding facility 74. The scraping arrangement 72 comprises at least one scraper device 2 according to any aspect or embodiment disclosed herein. In these embodiments there are provided two scraper devices 2, 2′. The scraping arrangement 72 further comprises a wire 12 and a wire driving motor arrangement 76.

The scraping arrangement 72 is arranged in connection with a feeding alley 78 of the animal holding facility 74. Animals in the animal holding facility 74 are kept in animal holding areas 80. Non-shown railings prevent the animals from walking into the feeding alley 78. The animals may extend their heads and necks through the railings to feed from the feeding alley 78. As the animals feed from the feeding alley 78, some of the feed may be pushed out of reach of the animals. Each of the two scraper devices 2, 2′, is arranged to scrape a surface 4, 4′ of the feeding alley 78 in order to displace the feed within reach of the animals. A guide member 10, 10′ of each scraper device 2, 2′ is arranged along a respective edge portion of the feeding alley 78.

In FIG. 5 each of the scraper devices 2, 2′ is illustrated with the scraper element 8, 8′ in a position pivoted away from the surfaces 4, 4′ to be scraped. The scraping arrangement 72 comprises a first pivot guiding element 81, 81′ and a second pivot guiding element 82, 82′ for each scraper device 2, 2′. Each of the first and second pivot guiding elements 81, 81′, 82, 82′ is adapted to bear against the scraper element 8, 8′ to pivot the scraper element 8, 8′ away from the surface 4, 4′ to be scraped at opposite ends of a traveling path of the scraper device 2, 2′. The first and second pivot guiding elements 81, 81′, 82, 82′ comprise inclined bars adapted to abut against the scraper element 8, 8′. As the wire 12 moves the scraper device 2, 2′ towards an end of the travelling path, the scraper element 8, 8′ makes contact with the inclined bar and is pivoted upwardly along the inclined bar as the scraper device 2, 2′ approaches its end position. As discussed above, in the end position one of the first or second release mechanisms of the scraper device 2, 2′ abuts against an actuator element, e.g. a cam element, to release the wire 12 from a locking engagement.

For illustrative purposes, in these embodiments two different scraper devices 2, 2′ are shown. A scraper blade arrangement 14 of a first scraper device 2 comprises a scraper edge 84 adapted to abut against the surface 4 to be scraped. The scraper edge 84 may be formed from metal or a synthetic material such as nylon or PTFE. A scraper blade arrangement 14′ of a second scraper device 2′ comprises a brush member 86 provided with bristles 88 to bear against the surface 4′ to be scraped.

The wire 12 is formed as an endless wire loop. The wire 12 extends around the feeding alley 78. The scraping arrangement 72 comprise wire directing elements 90 for directing the wire 12 along a wire path. The wire directing elements 90 may comprise guiding wheels adapted to pivot as the wire 12 is moved by the wire driving motor arrangement 76. Alternatively, one or more of the wire directing elements 90 may comprise a curved element comprising a groove through which the wire 12 may slide. The wire 12 connects to the wire driving motor arrangement 76. The wire driving motor arrangement 76 may comprise an electric motor and a transmission. The wire 12 may engage with the transmission. The wire driving motor arrangement 76 is arranged to drive the wire 12 in a forward direction and a reverse direction. Thus the first scraper device 2 may be dragged back and forth along its surface 4 to be scraped and the second scraper device 2′ may be dragged back and forth along its surface 4′ to be scraped by the wire 12 driven by the wire driving motor arrangement 76.

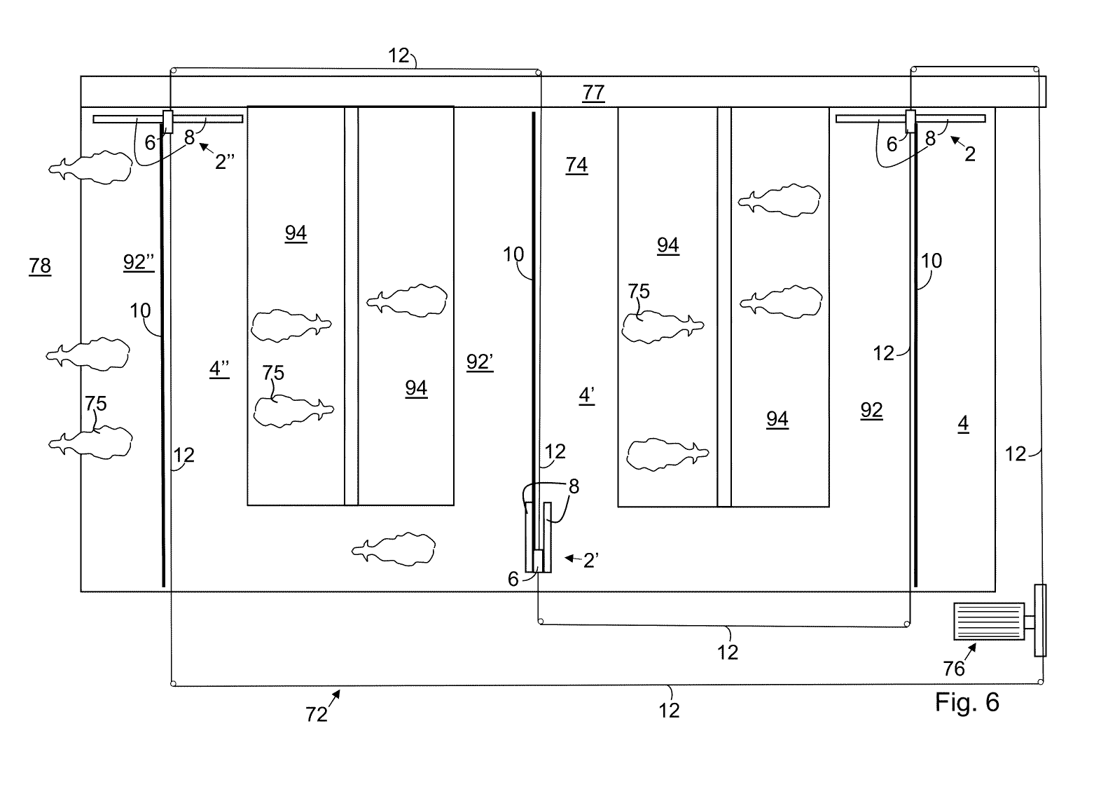

FIG. 6 illustrates embodiments of a scraper arrangement 72 for scraping surfaces of an animal holding facility 74. Animals 75 have been schematically illustrated in the animal holding facility 74. The scraper arrangement 72 comprises three scraper devices 2, 2,′, 2″, a wire 12 extending in a closed loop, and a wire driving motor arrangement 76. The three scraper devices 2, 2′, 2″ are arranged to be moved along a respective surface 4, 4′, 4″ to be scraped by the wire 12 and the wire driving motor arrangement 76. Each scraper device 2, 2′, 2″ is arranged for scraping manure into a manure gutter 77 arranged at one end of the surfaces 4, 4′, 4″ to be scraped. Each scraper device 2, 2′, 2″ may comprise a trolley 6 similar to the trolley 6 of the embodiments disclosed in FIGS. 1-4. However, the guiding member 10 for guiding the trolley 6 extends along and at a middle of the surface 4 to be scraped. The scraper element 8 extends on both sides of each trolley 6 and is pivotably connected to the trolley 8. The scraper element 8 is pivotable about a vertical axis, i.e. the scraper element 8 pivots in a plane parallel with the relevant surface 4, 4′, 4″ to be scraped. Thus, the scraper element 8 is pivoted to a folded position as it is moved in a direction away from the manure gutter 77 and pivoted to an extended position as it moves in a direction towards the manure gutter 77. In FIG. 6 this is illustrated by the two outer scraper devices 2, 2″ being moved by the wire 12 in a direction towards the manure gutter 7 with their scraper devices 8 in an extended position and the middle scraper device 2′ being moved by the wire 12 away from the manure gutter 77 with the scraper device 8 in a folded position.

The surfaces 4, 4′, 4″ to be scraped are formed by animal walking passages 92, 92′, 92″ in the animal holding facility 74. The animal walking passages 92, 92′, 92″ are arranged along animal resting areas 94 and an animal feeding alley 78.

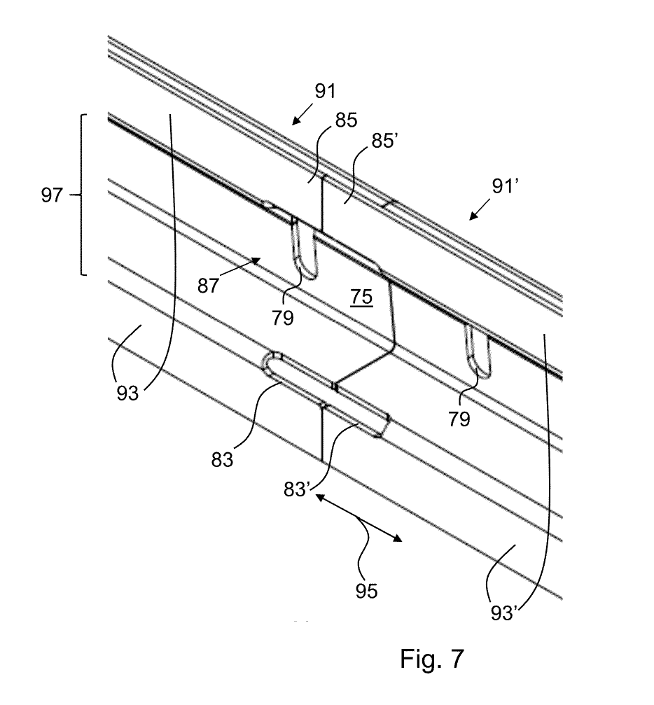

FIG. 7 illustrates embodiments of a guide rail 91 adapted to support a scraper device, e.g. a scraper device 2 as disclosed herein. The guide rail 91 may e.g. be made from a steel material, e.g. galvanized steel or stainless steel. End portions 85, 85′ of two guide rails 91, 91′ are shown in FIG. 7. The guide rail 91 is further illustrated in FIGS. 4 and 5. In FIG. 4 a cross section of the guide rail 91 is illustrated. In FIG. 5 two guide rails 91, 91′ are shown on two opposite sides of an animal feeding alley 78 of an animal holding facility 74. The guide rail 91 is adapted to be mounted to a supporting structure 99 of an animal holding facility 74, as illustrated in FIG. 4. The guide rail 91 is elongated and extends along a rail direction 95, see FIG. 5. Each guide rail 95 comprises two flanges 93, 93′, see FIGS. 4 and 7. The two flanges 93, 93′ are adapted to extend in a plane parallel with the supporting structure 99, see FIG. 4. The two flanges 93, 93′ are adapted to abut against guide elements 68 of the scraper device 2 as illustrated in FIG. 4.

The guide rail 91 comprises a U-shaped section 97 connected to the two flanges 93, 93′. The section 97 is arranged to space the two flanges 93, 93′ from each other and from the supporting structure 99, see FIGS. 4 and 7. The section 97 is arranged between the two flanges 93, 93′ such that the two flanges 93, 93′ extend out to the sides from the section 97. Thus, access to an inner surface 87 of the section 97 is permitted when the guide rail 91 with an outer surface 89 of the section 97 abuts against the supporting structure 99.

The guide rail 91 is provided with elongated through holes 79 in the U-shaped section 97. Connector elements, such as bolts, may thus extend through a bottom portion 75 of the U-shaped section 97 to mount the guide rail to a supporting structure. Owing to the elongated holes 79, the guide rail 91 may be first be provisionally attached to a supporting structure using e.g. bolts. Thereafter the bolts are tightened while the guide rail 91 is aligned with an adjoining guide rail 91′.

The bottom portion 75 of the U-shaped section 97 has bent shape such that the inner surface 87 is convex and the outer surface is concave, see FIG. 4. The guide rail 91, 91′ comprises two end portions 85, 85′, one end portion 85, 85′ each of two adjoining guide rails 91, 91′ are illustrated in FIG. 7. Each end portion 85, 85′ of the guide rails 91, 91′ is provided with at least one slot 83, 83′ extending in the rail direction 95. The at least one slot 83, 83′ is open towards an end of the guide rail 91, 91′.

This invention should not be construed as limited to the embodiments set forth herein. A person skilled in the art will realize that different features of the present invention may be combined to create embodiments other than those described herein, without departing from the scope of the present invention, as defined by the appended claims. It is also understood by those skilled in the art that not only one, two, or three scraper devices may be connected to one wire, but that more than three scraper devices may be connected to the wire. The wire engagement mechanisms need not comprise cam cleats or wire guiding wheels with ratchet mechanisms but may comprise any alternative mechanism, which may engage with the wire and which may be opened to release the wire from a locking engagement. The terms scrape and scraping are to be interpreted broadly and encompass any action involving dragging a device along a surface to displace material laying on the surface. Similarly, a scraper element and a scraper blade arrangement is to be interpreted as any element or arrangement adapted to displace material laying on a surface, when dragged along the surface. Although the invention has been described with reference to example embodiments, many different alterations, modifications and the like will become apparent for those skilled in the art. Therefore, it is to be understood that the foregoing is illustrative of various example embodiments and that the invention is defined only the appended claims.

As used herein, the term “comprising” or “comprises” is open-ended, and includes one or more stated features, elements, steps, components or functions but does not preclude the presence or addition of one or more other features, elements, steps, components, functions or groups thereof.

1. A scraper device (2) to be used in an animal holding facility (74), the scraper device (2) comprising:
a guide member (10);
a trolley (6) that is displaceable along the guide member (10) by a wire (12);
a scraper element (8) attached to the trolley (6), wherein, in use the scraper element (8) is dragged along a surface (4) to be scraped of the animal holding facility (74) to displace material laying on the surface (4) to be scraped;
a first wire engagement mechanism (18) connected to the trolley (6) and engaging the trolley (6) with the wire (12) in a first locking engagement, wherein the first wire engagement mechanism (18) has a first wire locking direction (22), a first wire release direction (24), and comprises a first release mechanism (26) that automatically releases the wire (12) from the first locking engagement upon actuation by a first actuator element; and
a second wire engagement mechanism (20) connected to the trolley (6) and engaging the trolley (6) with the wire (12)in a second locking engagement, wherein the second wire engagement mechanism (20) has a second wire locking direction (28), a second wire release direction (30), and comprises a second release mechanism (32) that automatically releases the wire (12) from the second locking engagement upon actuation by a second actuator element,
wherein the first and second wire locking directions (22, 28) are directed in opposite directions, and
wherein the first and second wire release directions (24, 30) are directed in opposite directions.

2. The scraper device (2) according to claim 1, wherein the trolley (6) comprises guide elements (68) that abut against the guide member (10).

3. The scraper device (2) according to claim 1, wherein the scraper element (8) is pivotably attached to the trolley (6) such that the scraper element (8) is pivotable away from the surface (4) to be scraped.

4. The scraper device (2) according to claim 1,
wherein the first wire engagement mechanism (18) comprises a first cam cleat (34) and the second wire engagement mechanism (20) comprises a second cam cleat (36), and
wherein each of the first and second cam cleats (34, 36) comprises cleat members that receive the wire (12) between the cleat members.

5. The scraper device (2) according to claim 4, wherein the first cam cleat (34) comprises a first fixed cleat member (38) fixedly connected to the trolley (6) and a first movable cleat member (40) movably connected to the trolley (6), and wherein the second cam cleat (36) comprises a second fixed cleat member (42) fixedly connected to the trolley (6) and a second movable cleat member (44) movably connected to the trolley (6).

6. The scraper device (2) according to claim 5, wherein the first movable cleat member (40) is pivotable about a first pivot axis (46) and the second movable cleat member (44) is pivotable about a second pivot axis (48).

7. The scraper device (2) according to claim 6,
wherein the first release mechanism (26) comprises the first movable cleat member (40) and a first follower element (50) connected to the first movable cleat member (40), the first follower element (50) pivot the first movable cleat member (40) upon actuation of the first follower element (50), and
wherein the second release mechanism (32) comprises the second movable cleat member (44) and a second follower element (52) connected to the second movable cleat member (44), the second follower element (52) pivoting the second movable cleat member (44) upon actuation of the second follower element (52).

8. The scraper device (2) according to claim 5, wherein the first fixed cleat member (38) and the second fixed cleat member (42) comprise wire engagement surfaces (45, 47) aligned along a wire direction (49) of the wire (12).

9. The scraper device (2) according to claim 1,
wherein the first wire engagement mechanism (18) comprises a first wire guiding wheel (100) rotatably connected to the trolley (6) and the second wire engagement mechanism (20) comprises a second wire guiding wheel (102) rotatably connected to the trolley (6), and
wherein each of the first and second wire guiding wheels (100, 102) comprises a wire receiving groove (104, 104′) having a surface that frictionally engages the wire (12).

10. The scraper device (2) according to claim 9, comprising a first ratchet mechanism (106) associated with the first wire guiding wheel (100) and a second ratchet mechanism (108) associated with the second wire guiding wheel (102).

11. The scraper device (2) according to claim 10, wherein the first ratchet mechanism (106) comprises a first gear (110) connected to, or forming part of, the first wire guiding wheel (100) and a first pawl (112) pivotably connected to the trolley (6), and wherein the second ratchet mechanism (108) comprises a second gear (114) connected to, or forming part of, the second wire guiding wheel (102) and a second pawl (116) pivotably connected to the trolley (6).

12. The scraper device (2) according to claim 11,
wherein the first release mechanism (26) comprises the first pawl (112) and a first abutment member (118) connected to the first pawl (112), the first abutment member (118) pivoting the first pawl (112) upon actuation of the first abutment member (118), and
wherein the second release mechanism (32) comprises the second pawl (116) and a second abutment member (120) connected to the second pawl (116), the second abutment member (120) pivoting the second pawl (116) upon actuation of the second abutment member (120).

13. The scraper device (2) according to claim 9, wherein each of the first and second wire guiding wheels (100, 102) comprises a further wire receiving groove (122, 122′), having a surface of that frictionally engages the wire (12).

14. The scraping arrangement (72) according to claim 1, further comprising a wire driving motor arrangement (76).

15. The scraping arrangement (72) according to claim 14, wherein the wire (12) forms an endless wire loop.

16. The scraping arrangement (72) according to claim 15, further comprising wire directing elements (90) for directing the wire (12) along a wire path.

17. The scraping arrangement (72) according to claim 14, wherein the wire driving motor arrangement (76) is arranged to drive the wire (12) in a forward direction and a reverse direction.

18. The scraping arrangement (72) according to claim 14, wherein the first actuator element comprises a first cam element (54) having a first cam surface (56) and the second actuator element comprises a second cam element (58) having a second cam surface (60), each of the first and second cam elements (54, 58) being separate from the trolley (6) and the wire (12) and being positionable at opposite ends of a traveling path (62) of the scraper device (2), wherein the first release mechanism (26) is actuated by the first cam surface (56) at a first end (64) of the traveling path (62), and wherein the second release mechanism (32) is actuated by the second cam surface (60) at a second end (66) of the traveling path (62).

19. The scraping arrangement (72) according to claim 18,
wherein the first release mechanism (26) comprises a first movable cleat member (40) and a first follower element (50) connected to the first movable cleat member (40), the first follower element (50) pivoting the first movable cleat member (40) upon actuation of the first follower element (50), and
wherein the second release mechanism (32) comprises a second movable cleat member (44) and a second follower element (52) connected to the second movable cleat member (44), the second follower element (52) pivoting the second movable cleat member (44) upon actuation of the second follower element (52),
wherein the first follower element (50) of the first release mechanism (26) abuts against the first cam surface (56) at the first end (64) of the traveling path (62) to actuate the first movable cleat member (40) of the first release mechanism (26), and wherein the second follower element (52) of the second release mechanism (32) abuts against the second cam surface (60) at the second end (66) of the traveling path (62) to actuate the second movable cleat member (44) of the second release mechanism (32).

20. The scraping arrangement (72) according to claim 18,
wherein the first release mechanism (26) comprises a first pawl (112) and a first abutment member (118) connected to the first pawl (112), the first abutment member (118) pivoting the first pawl (112) upon actuation of the first abutment member (118),
wherein the second release mechanism (32) comprises a second pawl (116) and a second abutment member (120) connected to the second pawl (116), the second abutment member (120) pivoting the second pawl (116) upon actuation of the second abutment member (120),
wherein the first abutment member (118) of the first release mechanism (26) abuts against the first cam surface (56) at the first end (64) of the traveling path (62) to actuate the first pawl (112) of the first release mechanism (26), and
wherein the second abutment member (120) of the second release mechanism (32) abuts against the second cam surface (60) at the second end (66) of the traveling path (62) to actuate the second pawl (116) of the second release mechanism (32).

21. The scraping arrangement (72) according to claim 20,
wherein the first wire engagement mechanism (18) comprises a first wire guiding wheel (100) rotatably connected to the trolley (6) and the second wire engagement mechanism (20) comprises a second wire guiding wheel (102) rotatably connected to the trolley (6),
wherein each of the first and second wire guiding wheels (100, 102) comprises a wire receiving groove (104, 104′) having a surface that frictionally engages the wire (12), and
wherein the wire (12) extends in at least one loop around the first and second wire guiding wheels (100, 102), the wire (12) at least partially extending through the wire receiving grooves (104, 104′) of the first and second wire guiding wheels (100, 102).

22. The scraping arrangement (72) according to claim 14, comprising a first pivot guiding element (81) (80) and a second pivot guiding element (82), each pivot guiding element (81, 82), when bearing against the scraper element (8), pivoting the scraper element (8) away from the surface (4) to be scraped, the first and second pivot guiding elements (81, 82) being located at opposite ends of a traveling path of the scraper device (2).

23. The scraping arrangement (72) according to claim 14, comprising at least one further said scraper device (2′, 2″), wherein the at least one further scraper device (2′, 2″) is arranged to scrape at least one further surface (4′, 4″) to be scraped of the animal holding facility (74) to displace material laying on said at least one further surface (4′, 4″) to be scraped.

24. The scraping arrangement (72) according to claim 2, further comprising:
a guide rail (91) that supports the scraper device (2), the guide rail (91) mounted to a supporting structure (99) of the animal holding facility (74), the guide rail (91) being elongated extending along a rail direction (95) and comprising two flanges (93, 93′), which two flanges (93, 93′) abut against the guide elements (68) of the scraper device (2),
wherein the guide rail (91) comprises a section (97) being connected to the two flanges (93, 93′), which section (97) is arranged to space the two flanges (93, 93′) from the supporting structure (99),
wherein the section (97) is substantially U-shaped and arranged between the two flanges (93, 93′) so as to space the two flanges (93, 93′) from each other, such that access to an inner surface (87) of the section (97) is permitted when an outer surface (89) of the section (97) abuts against the supporting structure (99).

25. The scraping arrangement (72) according to claim 24, wherein a bottom portion (75) of the U-shaped section (97) has a bent shape such that the inner surface (87) is convex and the outer surface (89) is concave.

26. The scraping arrangement (72) according to claim 24, wherein the guide rail (91) further comprises two end portions (85, 85′), wherein at each end portion (85, 85′) the guide rail 91 is provided with at least one slot (83, 83′) extending in the rail direction (95).

27. (canceled)

28. (canceled)
